(19) United States
(12) Patent Application Publication
(10) Pub. No.: US 2018/0043589 A1
(43) Pub. Date: Feb. 15, 2018

(54) TOOLING SYSTEMS AND METHODS TO FORM DECORATIVE MATERIAL ON A WORK-PIECE

(71) Applicant: Ford Global Technologies, LLC, Dearborn, MI (US)

(72) Inventors: Xuezhi Jin, Nanjing (CN); Wei Xu, Nanjing (CN); Jed Li, Nanjing (CN)

(21) Appl. No.: 15/667,187

(22) Filed: Aug. 2, 2017

(30) Foreign Application Priority Data
Aug. 10, 2016 (CN) 201610654304.9

(51) Int. Cl. B29C 45/14; B29C 45/16

(52) U.S. Cl. CPC B29C 45/14008; B29C 45/1671; B29C 2045/14049; B29K 2105/04

(57) ABSTRACT

A tooling system to form decorative material on a work-piece comprises a first mold and a second mold to receive and work-piece and the decorative material, a support configured to detachably connect the work-piece. The first mold includes a first lower mold piece, and a first left upper mold piece and a first right upper mold piece, and the second mold includes a second lower mold piece, and a second left upper mold piece and a second right upper mold piece. The support is configured to move the work-piece into or out the first and second molds consecutively during a process to form two layers of decorative material on the work-piece.

### RELATED APPLICATION

This application claims the benefit of Chinese Patent Application No.: CN 201610654304.9 filed on Aug. 10, 2016, the entire contents thereof being incorporated herein by reference.

### FIELD

This invention relates tooling systems and methods to form decorative material on a work-piece.

### BACKGROUND

When two layers of decorative material need to be formed on a work-piece, two sets of molds are required. In conventional technologies, each mold includes an upper mold and a lower mold pivotally connected with the upper mold. Each mold has a separate supporting system to support the work-piece during a forming process. Thus, the number of mold sets corresponds to the number of supporting system, which results in increased tooling cost and decreased efficiency. Further, in a process of forming two layers of decorative material on the work-piece, the work-piece needs to be delivered from one mold to another mold, which results in higher labor costs and a lower production efficiency. Thus, there is a need for a tooling system that forms decorative material on a work-piece with improved efficiency.

### SUMMARY

According to one aspect, a tooling system to form decorative material on a work-piece is provided. The tooling system comprises a first mold and a second mold to receive a work-piece and the decorative material and a support configured to detachably connect the work-piece. The first mold includes a first lower mold piece, and a first left upper mold piece and a first right upper mold piece, and the second mold includes a second lower mold piece, and a second left upper mold piece and a second right upper mold piece. The support is configured to move the work-piece into or out the first and second molds consecutively during a process to form the decorative material on the work-piece.

In one embodiment, the support may include a traverse rod and a plurality of vertical rods connected with the traverse rod, and the work-piece is connected to an end of the vertical rod.

In another embodiment, the support may include two support rods intersecting each other and a rotation shaft positioned at an intersecting point to rotate the two support rods, and the work-piece is connected to an end of one of the support rod.

In another embodiment, the first left upper mold piece and the first right upper mold is enclosed on the first lower mold to seal the work-piece inside and a through hole is formed at a connection between the first left upper mold piece and the first right upper mold piece to allow the end of the support to pass through. The second left upper mold piece and the second right upper mold is enclosed on the second lower mold to seal the work-piece inside and a through hole is formed at a connection between the second left upper mold piece and the second right upper mold piece to allow the end of the support to pass through.

In another embodiment, the first mold is configured to form a first decorative layer on the work-piece and the second mold is configured to form a second decorative layer on the first decorative layer.

In another embodiment, the work-piece is a steering wheel of a vehicle.

In another embodiment, the decorative material is foam.

According to another aspect of the present disclosure, a tooling system to form decorative material on work-pieces of a vehicle is provided. The tooling system comprises a support including a first end, a second end, a third end and a fourth end arranged consecutively, and connected to four work-pieces. The tooling system further includes a first g mold and a second mold corresponding the second end and the third end, respectively. Each of the first mold and the second mold includes a lower mold piece, a left upper mold piece and a right upper mold piece. The support is configured to be moveable and the first, second, third and fourth ends stop at positions of the first mold and the second mold, consecutively.

In one embodiment, the work-pieces are steering wheel. An outer profile of each of the first, second, third and fourth ends is the same as an outer profile of an end of a steering column to be connected with the steering wheel.

In another embodiment, at one step of a process to form decorative material on the work-pieces, the first end of the support is connected to a work-piece unprocessed, the second end is connected a work-piece placed in the first mold, the third end is connected to a work-piece placed in the second mold, and the fourth end is connected to a work-piece in a treatment station.

In another embodiment, the support may include a traverse rod, a first, second, third, and fourth vertical rods connected to the traverse rod, and wherein the first, second, third and fourth rods includes the first, second, third and fourth ends, respectively.

In another embodiment, the support may include a first support rod and a second support rod intersecting the first support rod. The first support rod includes the first and third ends, and the second support rod includes the second and the fourth ends.

In another embodiment, a cavity of the first mold may be different from a cavity of the second mold.

In another embodiment, a first semi-finished product is generated after a first foam layer is covered on the work-piece in the first mold, the second semi-product is generated after a second decorative layer is covered on the work-piece in the second mold, and the final product is generated after a surface treatment is performed the treatment station.

According to another aspect of the present disclosure, a method is provided to form at least two decorative material layers on a work-piece. The method comprising securing the work-piece on a support; moving the support to place the work-piece into a first mold to cover a first decorative layer on the work-piece to form a first semi-finished product; and moving the support further to place the first semi-finished product into a second mold to cover a second decorative layer on the first semi-finished product to form a second semi-finished product.

In one embodiment, the method further comprising moving the support further to place the second semi-finished product into a treatment station.

In another embodiment, the support is moved manually or by a driving device.

In another embodiment, the step of placing the work-piece into the first mold includes moving the work-piece into a first lower mold piece; and enclosing a first lower mold piece with a first left upper mold piece and a first right upper mold piece to seal the work-piece inside. The step of placing the first semi-finished product into the second mold includes moving the first semi-finished product into a second lower mold piece; and enclosing a second lower mold piece with a second left upper mold piece and a second right upper mold piece to seal the first semi-finished product inside.

In another embodiment, the support includes a first support rod and a second support rod intersecting the first support rod to form 90 between the first and second support rods, and the work-piece is detachably connected to one end of the first or the second support rod, and wherein each end of the support rotates 90 when moving the work-piece from the first mold to the second mold.

In another embodiment, the support includes a traverse rod and a plurality of vertical rods connected to the traverse rod, and the work-piece is connected to one end of the vertical rod, and wherein the end moves along a straight line or a curved path when moving the work-piece from the first mold to the second mold.

The tooling systems and methods of forming decorative material on a work-piece of the present disclosure improve the efficiency of the forming process. As the work-piece is mounted on the shared support, the work-pieced can be moved by the support between the different molds and thus does not need to be dismounted from the support during the forming process. The simplified process saves the labor cost and improves the production efficiency.

### BRIEF DESCRIPTION OF DRAWINGS

Example embodiments will be more clearly understood from the following brief description taken in conjunction with the accompanying drawings. The accompanying drawings represent non-limiting, example embodiments as described herein.

FIG. 1 is schematic diagram of a tooling system to form decorative material on a work-piece according to one embodiment of the present disclosure.

FIG. 2 is a schematic diagram of a tooling system to form decorative material on a work-piece according to another embodiment of the present disclosure.

FIG. 3 is a schematic diagram of a mold according to one embodiment of the present disclosure.

FIG. 4 is a cross section view of a work-piece according to one embodiment of the present disclosure.

FIG. 5 is an exploded view of a portion of a support and a work-piece, illustrating an assembling process.

FIG. 6 is a flowchart of a method to form decorative material on the work-piece.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

The disclosed systems and methods to form decorative material on a work-piece will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various systems and methods to form decorative material on a work-piece are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

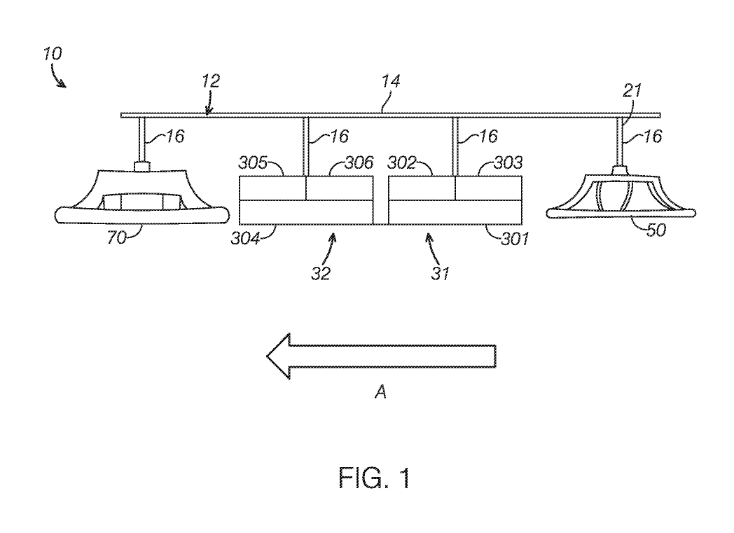

Referring to FIG. 1, a tooling system 10 to form decorative material on a work-piece is provided. The tooling system 10 comprises at least two molds such as a first mold 31 and a second mold 32 to receive the work-piece and form a first and second decorative material layers, respectively. The first mold 31 includes a lower mold piece 301, and a left upper mold piece 302 and a right upper mold piece 303 that match with the lower mold 301. The second mold 32 includes lower mold piece 304, and a left upper mold piece 305 and a right upper mold piece 303 that match with the lower mold 304. The tooling system 10 further includes a support 12 to detachably connect the work-piece 50. The support 12 drives the work-piece 50 and move into or out the first and second molds 31 and 32, successively.

The work-piece 50 is mounted on the supporter 12 and is moved between the first and second molds 31, 32 via the support 12 during a process to form two layers of decorative material on the work-piece 50. Each of the first and second molds 31, 32 of the tooling system 10 has two upper mold pieces and one lower mold piece. The two upper mold pieces can translate away and toward each other such that the work-piece can be moved into the first mold 31 for the formation of the first decorative layer and moved out when the formation is completed via the support easily. Thereafter, the work-piece 50 can be moved to the second mold 32 via the support. The molds of the present disclosure are different from the conventional mold which includes one upper mold piece pivotally connected to a lower mold piece. By using two separate upper mold pieces in the tooling system of the present disclosure, the left upper mold piece and the right upper mold piece can be moved toward each other to enclose the lower mold piece or move away each other via a linear movement such that it is easy to place the work-piece on the lower mold piece or move away from the lower mold piece via a support. As a result, labor cost can be reduced and the productivity can be increased.

In some embodiments, the decorative materials may include foam, plastic, resin or other material suitable for forming on a work-piece. The work-piece 50 may be a steering wheel frame, a gear shift rod, a vehicle seat, or other vehicle parts.

Referring to FIG. 1, the support 12 may include a traverse rod 14 and a plurality of vertical rods 16 connected with the traverse rod 14. The work-piece 50 is connected to an end 21 of a vertical rod 16. In some embodiments, the vertical rod 16 may be fixed on the traverse rod 11. As the vertical rods 16 are fixed on the traverse rod 14, the traverse rod 14 drives the vertical rods 16 to move and thus move the work-piece 50 between the first and second molds 31, 32 or other working stations of the process. In some embodiments, the vertical rod 16 may be moveably connected on the traverse rod 14 and slidable along the traverse rod 14. In such configuration, the traverse rod 14 is stationary as a rail, and the vertical rod 16 moves along the traverse rod 14 to drive the work-piece 50 to move between the first and second molds 31, 32 and other work stations of the process. In some embodiments, the traverse rod 14 may be a straight rod as shown in FIG. 1. The work-piece 50 moves in a direction A along a linear path. In some embodiments, the traverse rod 14 may be configured to have an annular shape or a ring shape. The supporter 10 may be driven to rotate. In some embodiments, four work-pieces 50 may be connected to the support 12. In the depicted embodiment, the work-piece 50 and a final product 70 (i.e., a work-piece went through all the steps of the process) may be arranged to be consecutively on the support 12. The support 12 may rotate during the process of forming the decorative material. When the process is completed, the final product 70 is taken off from the support 12. Another work-piece is loaded on that vertical rod 16 such that the newly loaded work-piece will go through the process as the support 12 moves. In this way, the automation of process can be achieved. In some embodiments, the support 12 may be driven by an actuator such as a motor (not shown). The speed and on/off of the actuator may be controlled automatically by a controller. In some embodiments, the support 12 may be moved manually by an operator.

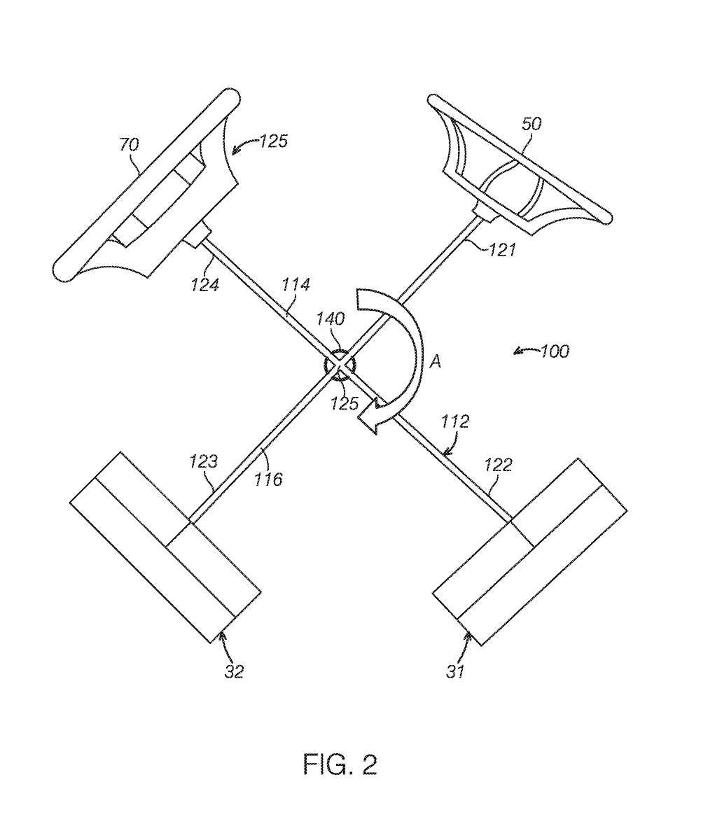

Referring to FIG. 2, a tooling system 100 according to another embodiment of the present disclosure is provided. Similar to the tooling system 10, the tooling system includes the first and second molds 31 and 32. The tooling system 100 further include a support 112 having at least two support rods 114, 116. The two support rods 114, 116 intersect each other and a rotation shaft 140 positioned at an intersecting point 125 is configured to rotate the two support rods 114, 116. The work-piece 50 is connected to an end of one of support rods 114, 116. In other words, the support may be configured as a cross shape. The rotation shaft 140 at the intersection 125 drives the support rods 114, 116 to rotate. One of support rods 114, 116 drives the work-piece 50 in or out of the two molds 31, 32 consecutively such that two layers of decorative materials are formed on the work-piece 50. In the depicted embodiment, the work-piece 50 and a final product 70 may be arranged to be next each other. The support 112 may rotate to place the work-piece 50 into the first mold 31, the second mold 32 and a treatment station 125 successively. A surface treatment may be performed on a second-finished product at the treatment station 125. Upon completion of final treatment on the work-piece 50 at the treatment station 125, the final product 70 is generated and then removed from the support rod 114. The support may move to next position and another work-piece 50 is loaded to continue the process of forming the decorative material on a work-piece. In this way, an automation production line can be achieved.

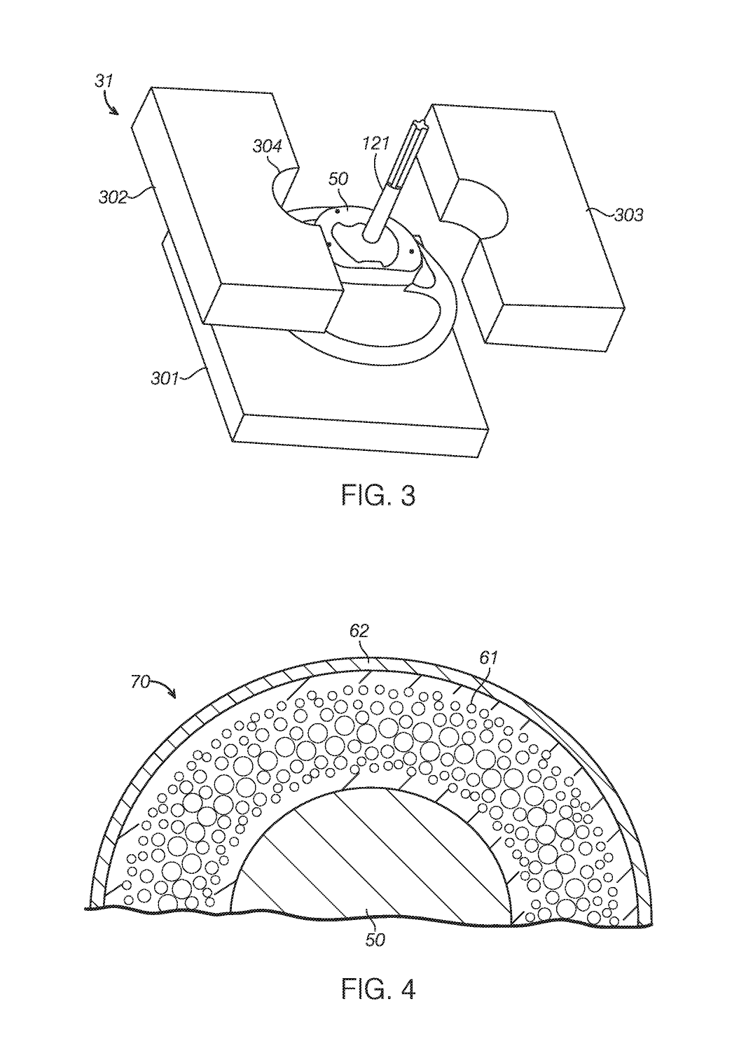

Referring to FIG. 3, an exploded view of an example first mold 31 is illustrated. The left upper mold piece 302 and the right upper mold piece 303 are moveable between an open position and a use position. At the use position, the left upper mold piece 302 and the right upper mold piece 303 cover the lower mold piece 301 to seal the work-piece 50 inside. The left upper mold piece 302 and the right upper mold piece 303 may be moved between the open position or the use position by any appropriate driving mechanisms in the art. Alternatively, the opening and closing of the mold may be performed manually. A through hole 304 is formed at a connection between the left upper mold piece 302 and the right upper mold piece 303 to allow the end 121, or 21 of the support to pass through. Such configuration makes it possible that the work-piece 50 is not dismounted from the support 112 and moves between the different molds or different work stations. Further, the configuration makes it easier to load and unload the work-piece 50 from the molds 31. The mold 31 is at the use position when the work-piece 50 is placed on the lower mold piece 301 and covered with the left upper mold piece 302 and right upper mold piece 303. The process can save labor and improve an efficiency of decorative material formation process. The second mold 32 may have a structure similar to the first mold 31, that is, the second mold 32 includes a lower mold piece 304, a left upper mold piece 305 and a right upper mold piece 306 as shown in FIG. 1. The cavity in the first mold 31 and the second mold 32 may be different to form the decorative layers having different configuration or thickness.

Referring to FIGS. 1 and 2, the support 12 or 112 includes a plurality of ends to secure the work-piece 50. That is, a plurality of work-pieces 50 can be loaded into the tooling system to perform the different steps of forming decorative materials and/or additional treatment simultaneously. As such, a high process efficiency can be achieved.

Referring to FIG. 4, a cross section of the work-piece covered with decorative layers is shown. As described above, the tooling systems 10 and 100 include a first mold 31 and a second mold 32. The first mold 31 is configured to form a first decorative layer 61 on the work-piece 50 and the second mold 32 is configured to form a second decorative layer 62 on the first decorative layer 61. It will be understood that the second decorative material layer 62 may cover the entire first decorative material layer 61, or a portion of the first decorative material layer 61. It will be understood that the tooling system may include more than two molds to form multiple decorative material layers on the work pieces 50.

Referring to FIGS. 1 and 2, another aspect of the invention provides a tooling system to form foam material on a steering wheel of a vehicle. The tooling system 10 and 100 comprises a support 12, a first mold 31 and a second mold 32. FIG. 1 shows that the ends of four vertical rod 16 are connected to four work-pieces. FIG. 2 shows the ends of the support rods 114, 116 are connected to four work-pieces. In this way, the different steps of the process may be performed on different work-pieces at the same time. In the embodiment depicted in FIG. 2, at one time period, a first end 121 is connected to a steering wheel frame 50 that is unprocessed, a second end 122 is connected to a first semi-finished product, a third end 123 is connected to a second semi-finished product, and a fourth end 124 is connected to a final product 70. The first end 121, the second end 122, the third end 123, and the fourth end 124 are next to each other in an order and moveable along a direction A from the first end 121 to the fourth end 124. The first mold 31 and the second mold 32 correspond the second end 122 and the third end 123, respectively and are used to receive the steering wheel and foam for the formation of the foam layers on the steering wheel.

The tooling system 10 and 100 to form foam material on a steering wheel of the present disclosure load a steering wheel frame 50 on the support 12 or 112. The steering wheel frame 50 is moved between the two molds 31, 32 by support 12, 112 to form two layers of foam materials on the steering wheel 50. In this way, the multiple work-pieces can be processed at the same time to improve the efficiency. There is no need to dismounted the work-piece when the work-piece goes through the different steps of the process, which save the labor cost.

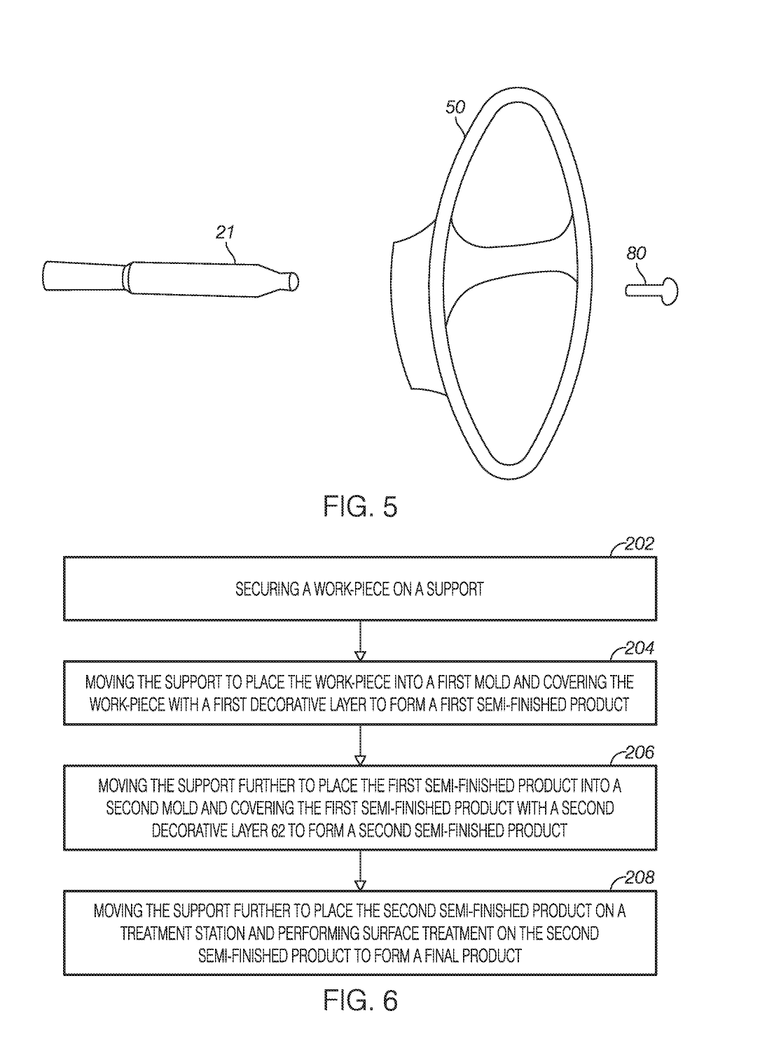

Referring to FIG. 5, An outer profile of the first end 21 of vertical rod 16 or an outer profile of the first end 121, the second end 122, the third end 123 and the fourth end 124 of support rods 114, 116 may be configured to be the same as an outer profile of an end of a steering column connected with the steering wheel. With such configuration, the end of the support to be connected with the steering wheel is standardized for a quick installation of the steering wheel with an assembling hole of the steering column. The first end 121 is connected with the steering wheel frame 50 via a threaded bolt 80. Similarly, the second end 122 is connected with the first semi-finished product via a threaded bolt, the third end 123 is connected with the second semi-finished product via a threaded bolt, and the fourth end 124 is connected with the final product 70 via a threaded bolt. Connection via thread nut 80 further achieves a quick installation of the support 12 and 112 with the steering wheel.

It should be understood that the first semi-finished product refers to a work-piece or a steering wheel frame covered with a first foam layer 61. The second semi-product refers to the first semi-finished product covered with a second decorative layer 62. The final product 70 refers to the second semi-finished product after a surface treatment. The surface treatment may be any appropriate treatment method commonly used in the art, such as an edge cutting, a surface polishing, and a surface covering.

Referring FIG. 6, a method 200 to form decorative materials on a work-piece is provided. At 202, the method 200 comprises securing the work-piece on a support. For example, the work-piece may be detachably secured on an end of the vertical rod of the support 12 or an end of the support rod of the support 112 as illustrated in FIGS. 1 and 2. At 204, the method 200 includes moving the support to place the work-piece into a first mold and covering the work-piece with a first decorative layer to form a first semi-finished product. At 206, the method 200 includes moving the support further to place the first semi-finished product into a second mold and covering the first semi-finished product with a second decorative layer 62 to form a second semi-finished product. At 208, the method includes moving the support further to place the second semi-finished product on a treatment station and performing surface treatment on the second semi-finished product to form a final product. Referring to FIG. 3, the step 204 of placing the work-piece into the first mold 31 comprising moving the work-piece into a first lower mold piece; and enclosing a first lower mold piece with a first left upper mold piece and a first right upper mold piece to seal the work-piece inside. The step 206 of placing the first semi-finished product into the second mold 32 comprising moving the first semi-finished product into a second lower mold piece and enclosing a second lower mold piece with a second left upper mold piece and a second right upper mold piece to seal the first semi-finished product inside.

Referring to FIG. 2, when the method 200 is implemented in the tooling system 100, the angle between the support rods 114 and 116 is about 90°. Each movement of the support 112 is configured to rotate the support rods one fourth of a circle or 90° around a rotating shaft.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

1. A tooling system to form decorative material on a work-piece, comprising:
a first mold and a second mold to receive a work-piece and the decorative material, wherein the first mold includes a first lower mold piece, and a first left upper mold piece and a first right upper mold piece, and the second mold includes a second lower mold piece, and a second left upper mold piece and a second right upper mold piece;
a support configured to detachably connect the work-piece,
wherein the support is configured to move the work-piece into or out the first and second molds consecutively during a process to form the decorative material on the work-piece.

2. The tooling system of claim 1, wherein the support includes a traverse rod and a plurality of vertical rods connected with the traverse rod, and wherein the work-piece is connected to an end of the vertical rod.

3. The tooling system of claim 1, wherein the support includes two support rods intersecting each other and a rotation shaft positioned at an intersecting point to rotate the two support rods, and wherein the work-piece is connected to an end of one of the support rod.

4. The tooling system of claim 2, wherein the first left upper mold piece and the first right upper mold is enclosed on the first lower mold to seal the work-piece inside and a through hole is formed at a connection between the first left upper mold piece and the first right upper mold piece to allow the end of the support to pass through and wherein the second left upper mold piece and the second right upper mold is enclosed on the second lower mold to seal the work-piece inside and a through hole is formed at a connection between the second left upper mold piece and the second right upper mold piece to allow the end of the support to pass through.

5. The tooling system of claim 1, wherein the first mold is configured to form a first decorative layer on the work-piece and the second mold is configured to form a second decorative layer on the first decorative layer.

6. The tooling system of claim 1, wherein the work-piece is a steering wheel of a vehicle and wherein the decorative material is foam.

7. A tooling system to form decorative material on work-pieces of a vehicle, comprising:
a support, wherein the support includes a first end, a second end, a third end and a fourth end arranged consecutively, and wherein the first, second, third and fourth ends are connected to four work-pieces; and
a first mold and a second mold corresponding the second end and the third end, respectively, wherein each of the first mold and the second mold includes a lower mold piece, a left upper mold piece and a right upper mold piece,
wherein the support is configured to be moveable and the first, second, third and fourth ends stop at positions of the first mold and the second mold, consecutively.

8. The tooling system of claim 7, wherein the work-pieces are steering wheel, wherein an outer profile of each of the first, second, third and fourth ends is the same as an outer profile of an end of a steering column to be connected with the steering wheel.

9. The tooling system of claim 7, wherein at one step of a process to form decorative material on the work-pieces, the first end of the support is connected to a work-piece unprocessed, the second end is connected a work-piece placed in the first mold, the third end is connected to a work-piece placed in the second mold, and the fourth end is connected to a work-piece in a treatment station.

10. The tooling system of claim 9, wherein the support includes a traverse rod and a first, second, third, and fourth vertical rods connected to the traverse rod, and wherein the first, second, third and fourth vertical rods include the first, second, third and fourth ends, respectively.

11. The tooling system of claim 9, wherein the support includes a first support rod and a second support rod intersecting the first support rod, and wherein the first support rod includes the first and third ends, and the second support rod includes the second and the fourth ends.

12. The tooling system of claim 7, wherein a cavity of the first mold is different from a cavity of the second mold.

13. The tooling system of claim 9, wherein a first semi-finished product is generated after a first foam layer is covered on the work-piece in the first mold, the second semi-product is generated after a second decorative layer is covered on the work-piece in the second mold, and the final product is generated after a surface treatment is performed the treatment station.

14. A method to form at least two decorative material layers on a work-piece, comprising:
securing the work-piece on a support;
moving the support to place the work-piece into a first mold and covering a first decorative layer on the work-piece to form a first semi-finished product;
moving the support further to place the first semi-finished product into a second mold and covering a second decorative layer on the first semi-finished product to form a second semi-finished product.

15. The method of claim 14, further comprising moving the support further to place the second semi-finished product into a treatment station.

16. The method of claim 14, wherein the support is moved manually or by a driving device.

17. The method of claim 14, wherein the step of placing the work-piece into the first mold includes moving the work-piece into a first lower mold piece; and enclosing a first lower mold piece with a first left upper mold piece and a first right upper mold piece to seal the work-piece inside, and wherein the step of placing the first semi-finished product into the second mold includes moving the first semi-finished product into a second lower mold piece; and enclosing a second lower mold piece with a second left upper mold piece and a second right upper mold piece to seal the first semi-finished product inside.

18. The method of claim 14, wherein the support includes a first support rod and a second support rod intersecting the first support rod to form 90° between the first and second support rods, and the work-piece is detachably connected to one end of the first or the second support rod, and wherein each end of the support rotates 90° when moving the work-piece from the first mold to the second mold.

19. The method of claim 14, wherein the support includes a traverse rod and a plurality of vertical rods connected to the traverse rod, and the work-piece is connected to one end of the vertical rod, and wherein the end moves along a straight line or a curved path when moving the work-piece from the first mold to the second mold.

20. The tooling system of claim 3, wherein the first left upper mold piece and the first right upper mold is enclosed on the first lower mold to seal the work-piece inside and a through hole is formed at a connection between the first left upper mold piece and the first right upper mold piece to allow the end of the support to pass through and wherein the second left upper mold piece and the second right upper mold is enclosed on the second lower mold to seal the work-piece inside and a through hole is formed at a connection between the second left upper mold piece and the second right upper mold piece to allow the end of the support to pass through.
